(19) United States
(12) Patent Application Publication
(10) Pub. No.: US 2007/0091326 A1
(43) Pub. Date: Apr. 26, 2007

(54) DEVICE AND METHOD FOR MEASURING PROPERTIES OF MULTI-SEGMENT FILTERS OR COMBINATIONS OF FILTER SEGMENTS

(75) Inventors: Dierk SCHROEDER, Hamburg (DE); Siegfried HAPKE, Geesthacht (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/535,691

(22) Filed: Sep. 27, 2006

(30) Foreign Application Priority Data
Sep. 28, 2005 (DE) 10 2005 046 581.1

(51) Int. Cl. G01B 11/14

(52) U.S. Cl. 356/625; 131/907

(57) ABSTRACT

Device and method for measuring properties of combination of filter segments of the tobacco-processing industry. The device includes an illumination device structured and arranged to essentially uniformly illuminate, in a longitudinally axial manner, at least one section of the combination of filter segments, and a photodetector. The illumination device images a first line of electromagnetic radiation on the combination of filter segments having an extension transverse to the longitudinal axis of the combination of filter segments smaller than a diameter of the combination of filter segments.

### CROSS-REFERENCE TO RELATED APPLICATIONS

The present application claims priority under 35 U.S.C. §119 of German Patent Application No. 10 2005 046 581.1, filed on Sep. 28, 2005, the disclosure of which is expressly incorporated by reference herein in its entirety.

### BACKGROUND OF THE INVENTION

1. Field of the Invention

The invention relates to a device for measuring properties of multi-segment filters or combinations of filter segments of the tobacco-processing industry, an illumination device and a photodetector being provided, whereby an illumination essentially uniform in a longitudinally axial manner of at least one section of a multi-segment filter or a combination of filter segments is rendered possible by means of the illumination device. The invention furthermore relates to a method for measuring properties of multi-segment filters or combinations of filter segments of the tobacco-processing industry.

2. Discussion of Background Information

Various errors can occur in the production of multi-segment filters, upstream of which an assembly of filter segments is usually arranged, such as, e.g., transposed filter segments or filter components, a missing filter segment, an incorrect position or the insertion of a filter segment with an incorrect length, a gap between filter segments and, e.g., a filter segment, the longitudinal axis of which is tilted with respect to the other filter segments, e.g., by 90°.

Known devices and methods for measuring properties of multi-segment filters or combinations of filter segments or methods for quality assurance of multi-segment filters or combinations of filter segments are used to try and detect such errors and to eject the then defective multi-segment filters or combinations of filter segments from further processing, so that, e.g., no defective filter cigarettes are produced. Multi-segment filters are usually filters that are assembled from different filter materials, such as, e.g., acetate filter segments, cellulose filter segments, filter segments containing granular material, e.g., comprising activated charcoal granular material and the like.

A device for measuring properties of multi-segment filters of the tobacco-processing industry with the transmission method is known from WO 03/055338 A2, an illumination device and a photodetector being provided, whereby an irradiation essentially uniform in a longitudinally axial manner of a multi-segment filter is rendered possible by means of the illumination device, whereby the photodetector is arranged inside a conveyor element that is provided to convey at least multi-segment filters. Moreover, from this document a system is known for measuring properties of rod-shaped articles or of components of rod-shaped articles of the tobacco-processing industry which can be subsequently joined together to form a rod-shaped article, in particular of multi-segment filters and/or filter cigarettes provided with multi-segment filters, whereby a first measuring device is provided, by means of which the articles or components of the articles can be measured with a reflection method, whereby a second measuring device is provided by means of which the articles or components of the articles can be measured with a transmission method.

### SUMMARY OF THE INVENTION

The present invention provides a method and device with increased measurement precision to increase the quality control of multi-segment filters or combinations of filter segments and the filter cigarettes to be formed therefrom.

According to the invention, a device is provided for measuring properties of multi-segment filters or combinations of filter segments of the tobacco-processing industry. An illumination device and a photodetector are provided, in which an illumination essentially uniform in a longitudinally axial manner of at least one section of a multi-segment filter or a combination of filter segments is rendered possible by the illumination device. In this manner, the illumination device images a first line of electromagnetic radiation on the multi-segment filters or combinations of filter segments of the tobacco-processing industry, the extension of which transverse to the longitudinal axis of the multi-segment filter or the combination of filter segments is smaller than the diameter of the multi-segment filter or the combination of filter segments.

Longitudinally axial areas of the multi-segment filters or the combination of filter segments can be illuminated in a very targeted manner through the device according to the invention. In this way, the areas can be those which ensure a high contrast for the respective filter segments, so that the quality of the measurement is improved. In particular, a higher contrast in the measurement can be generated through the device according to the invention, which leads to more precise measurement results.

Within the scope of this invention, imaging a first line also refers to, in particular, shining on, illuminating, and the like. The electromagnetic radiation is preferably light. Within the scope of the invention, longitudinally axial means along the axis of the multi-segment filters or the combination of filter segments or the respective filter segments, which are usually circular or elliptical in cross section. Thus, longitudinally axial means essentially perpendicular to the cross section of these segments or the filters. Longitudinally axial also means in particular that the first line can lie on the surface of the multi-segment filters or the combination of filter segments. Multi-segment filters or combinations of filter segments are also understood in particularly to be multi-segment filters or combinations of filter segments provided with wrapping material. The properties of multi-segment filters or the combination of filter segments can also be measured on a filter cigarette. The device according to the invention is therefore also suitable in particular for measuring the multi-segment filters or the combination of filter segments in finished filter cigarettes.

A particularly precise measurement is possible if the extension of the first line transverse to the longitudinal axis of the multi-segment filter or the combination of filter segments is less than half, in particular less than a quarter, in particular less than one eighth of the diameter of the multi-segment filter or the combination of filter segments or of the diameter of a filter segment. The extension of the first line can be, e.g., between 0.5 mm and 2 mm. The illumination device is preferably a linear laser.

According to the invention, a device is provided for measuring properties of multi-segment filters or combinations of filter segments of the tobacco-processing industry. An illumination device and a photodetector are provided. An illumination essentially uniform in a longitudinally axial manner of at least one section of a multi-segment filter or a combination of filter segments is possible by the illuminating device, and the photodetector includes an optical system that images a second line in a longitudinally axial manner on the multi-segment filter or the combination of filter segments. The second line hereby also preferably has an extension that is smaller transverse to the longitudinal axis of the multi-segment filter or the combination of filter segments than the diameter (D) of the multi-segment filter or the combination of filter segments. The extension can also be less than half, in particular less than a quarter, in particular less than an eighth of the diameter (D) of the multi-segment filter or the combination of filter segments and can preferably be in a range of 0.5 mm to 5 mm, and preferably in a range of 0.5 mm to 2 mm. Through the device according to the invention, it is possible to scan in a very targeted manner corresponding longitudinally axial regions of the multi-segment filters or the combinations of filter segments or the surface of the multi-segment filters or the combinations of filter segments or to measure whether the desired properties are present.

Within the scope of the invention, imaging a second line refers to, in particular, recording an image of the line or detecting the brightness of the line or the color(s). To this end, an optical system can be imaged a second line on a detector that is sensitive to the electromagnetic radiation.

If the second line is arranged to the edge of the multi-segment filter or the combination of filter segments, particular defects can be ascertained very efficiently, such as, e.g., a tipping of filter segments with respect to other filter segments. The edge of a multi-segment filter or a combination of filter segments is preferably arranged at the edge of the object to be observed when the multi-segment filter or the combination are observed from their photodetectors.

The photodetector preferably includes a linear camera, in particular CCD (charge coupled device) lines. Linear cameras or CCD lines are known per se. Reference is hereby made by way of example to DE 36 28 088 C2 in which corresponding CCDs are described. A linear camera preferably includes at least one CCD.

If the second line is spatially apart from the first line, not only can reflected radiation be measured, but transmitted rays or radiation, i.e., rays that pass from the illuminated line (first line) to the observed line (second line) through the material of the filter segments. Through this filter segments that are essentially the same in terms of color or brightness, but made of different material, can be discerned very well, since the transmission coefficients of electromagnetic radiation are different with different materials.

If two first lines are provided, such that one of the two first lines lies on the second line, a mixture of reflected and transmitted radiation can be recorded. If two second lines are provided, such that one of the two second lines lies on the first line, a very precise measurement of the properties of the multi-segment filters or the combination of filter segments is possible.

According to the invention, a machine of the tobacco-processing industry includes a device according to the invention described above.

Moreover, the invention is directed to a method for measuring properties of multi-segment filters or combinations of filter segments of the tobacco-processing industry that includes:
Illuminating a multi-segment filter or the combination of filter segments with a first line of electromagnetic radiation,
Recording the electromagnetic radiation reflected and/or scattered by the multi-segment filter or the combination of filter segments,
Comparing the recorded radiation with, in particular predetermined, desired values, such that, in the event of a deviation beyond a predetermined tolerance range, the result of the measurement is a defective multi-segment filter or a defective combination of filter-segments. In this way, the extension of the first line transversely to the longitudinal axis of the multi-segment filter or the combination of filter segments is smaller than the diameter of the multi-segment filter or the combination of filter segments.

A very precise measurement and thus a very good quality control of the multi-segment filters or combination of filter segments is possible through the method according to the invention.

The precision of the measurement is increased if the extension of the first line transversely to the longitudinal axis of the multi-segment filter or the combination of filter segments is less than half, in particular less than a quarter, in particular less than an eighth of the diameter of the multi-segment filter or the combination of filter segments.

The invention is directed to a method for measuring properties of multi-segment filters or combinations of filter segments of the tobacco-processing industry that includes:
Illuminating a multi-segment filter or the combination of filter segments with a first line of electromagnetic radiation,
Recording the electromagnetic radiation reflected and/or scattered by the multi-segment filter or the combination of filter segments,
Comparing the recorded radiation with, in particular predetermined, desired values, such that, in the event of a deviation exceeding a predetermined tolerance range the result of the measurement is a defective multi-segment filter or a defective combination of filter segments. In this way, a second line is imaged in a longitudinally axial manner on the multi-segment filter or the combination of filter segments by a recording device to record the electromagnetic radiation.

Preferably the second line is less than half, in particular less than a quarter, in particular less than an eighth of the diameter of the multi-segment filter or the combination of filter segments.

If the second line is arranged at the edge of the multi-segment filter or the combination of filter segments, in particular on the surface thereof, specific defects in the combination of filter segments or defects in the multi-segment filter can be detected very precisely, which defects could not have been detected or only poorly detected with an arrangement of the second line essentially in the center of the multi-segment filter or the combination of filter segments. The second line is preferably spatially apart from the first line. The second line preferably lies on the first line. Two first lines are preferably provided, whereby one of the two first lines lies on the second line. Two second lines are preferably provided, whereby one of the two second lines lies on the first line.

The present invention is directed to a device for measuring properties of combination of filter segments of the tobacco-processing industry. The device includes an illumination device structured and arranged to essentially uniformly illuminate, in a longitudinally axial manner, at least one section of the combination of filter segments, and a photodetector. The illumination device images a first line of electromagnetic radiation on the combination of filter segments having an extension transverse to the longitudinal axis of the combination of filter segments smaller than a diameter of the combination of filter segments.

In accordance with a feature of the invention, the combination of filter segments can include multi-segment filters.

According to another feature of the present invention, the extension of the first line transverse to the longitudinal axis of the combination of filter segments may be less than half the diameter of the combination of filter segments. Further, the extension of the first line can be less than one quarter of the diameter of the combination of filter segments. Still further, the extension of the first line may be less than one eighth of the diameter of the combination of filter segments.

According to the instant invention, the illumination device may include a linear laser.

The photodetector can include an optical system that images a second line in a longitudinally axial manner on the combination of filter segments. The second line may be arranged at an edge of the combination of filter segments.

According to a still further feature of the invention, the photodetector can include a linear camera. Moreover, the photodetector may include a charged coupled device line.

The second line can be spatially apart from the first line. The illumination device may further image another first line, such that the another first line on the second line. Further, the photodetector may further image another second line, such that the another second line lies on the first line.

The present invention is directed to a method for measuring properties of combinations of filter segments of the tobacco-processing industry. The method includes illuminating the combination of filter segments with a first line of electromagnetic radiation, recording the electromagnetic radiation at least one of reflected and scattered by the combination of filter segments, and comparing the recorded radiation with predetermined, desired values, and when a deviation beyond a predetermined tolerance range is detected, the combination of filter segments are deemed defective. An extension of the first line transversely to the longitudinal axis of the combination of filter segments is smaller than a diameter of the combination of filter segments.

According to a feature of the instant invention, the combination of filter segments may include multi-segment filters.

The extension of the first line transversely to the longitudinal axis of the combination of filter segments may be less than half of the diameter of the combination of filters. Further, the extension of the first line can be less than one quarter of the diameter of the combination of filter segments. Moreover, the extension of the first line can be less than one eighth of the diameter of the combination of filter segments.

The recording of electromagnetic radiation may include imaging a second line in a longitudinally axial manner on the combination of filter segments by a recording device. The second line can be arranged at an edge of the combination of filter segments. Further, the second line can be spatially apart from the first line, or the second line may lie on the first line.

In accordance with still another feature of the present invention, another first line can be illuminated, such that one of the first line and the another first line lie on the second line. Moreover, another second line can be imaged, such that one of the second line and the another second line lie on the first line.

The invention is directed to a machine of the tobacco-processing industry with the above-described device.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1a diagrammatically illustrates a filter segment arrangement with transposed filter components,

FIG. 1b diagrammatically illustrates a signal over a length of path along the filter segment combination from FIG. 1a,

FIG. 2a diagrammatically illustrates a filter segment combination with a detached filter segment,

FIG. 2b diagrammatically illustrates a length of path along the filter segment combination from FIG. 2a,

FIG. 3a diagrammatically illustrates a filter segment combination with a filter segment in an incorrect position,

FIG. 3b diagrammatically illustrates a length of path along the filter segment combination from FIG. 3a,

FIG. 4a diagrammatically illustrates a part of a multi-segment filter with a gap between two filter segments,

FIG. 4b diagrammatically illustrates a length of path along the multi-segment filter from FIG. 4a,

FIG. 5a diagrammatically illustrates a filter segment combination with a tilted filter segment,

FIG. 5b diagrammatically illustrates a signal over a length of path along the filter segment combination from FIG. 5a along the observation line 16,

FIG. 5c diagrammatically illustrates a signal over a length of path along the filter segment combination from FIG. 5a along the observation line 17,

FIG. 6 diagrammatically illustrates a measurement in transmission according to the invention,

FIG. 7 diagrammatically illustrates a measuring device according to the invention,

FIG. 8 diagrammatically illustrates another measuring device according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

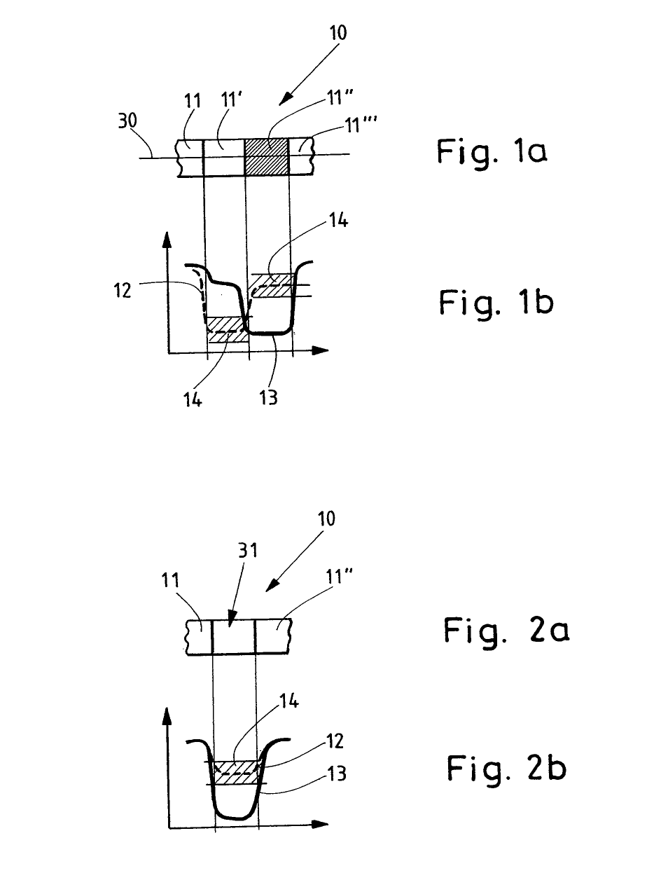

New filter materials are increasingly being used in the cigarette industry. One particular focus is the use of so-called multi-segment filters. These are filters that are assembled from different filter materials. Manufacturing defects can occur in the production of these filters. The correspondingly defective products should not be processed further in the process. Some defects in particular are mentioned below with reference to FIGS. 1 through 5.

FIG. 1 shows in diagrammatic representation a filter segment combination 10 comprising filter segments 11, 11′, 11″ and 11′″ which can be different or which can be at least in part the same. Furthermore, a longitudinal axis 30 is indicated diagrammatically in FIG. 1a. The defect has now occurred in the filter segment combination 10 according to FIG. 1a that the filter segments 11′ and 11″ have been transposed. With, e.g., a reflection measurement of these filter segments 11′ and 11″, whereby the filter segment 11′ reflects more strongly than the filter segment 11″, with the correct arrangement of the filter components 11′ and 11″ a signal curve 13 would result that essentially corresponds to the desired curve 12, which is shown in FIG. 1b. FIG. 1b is a schematic diagram in which a signal strength is plotted on the coordinate and the way along the filter segment combination 10 on the abscissa. The same applies to FIGS. 2b, 3b, 4b, 5b and 5c.

The interfaces between the filter segments 11 through 11″ are correspondingly drawn by lines indicated from FIG. 1a to FIG. 1b in order to make it easier to identify the correlations with the corresponding curves 12 and 13. Furthermore, FIG. 1b also shows a tolerance range 14 in the scope of which a deviation in the measurement of the filter segment combination 10 would be tolerated. In this case it can be clearly seen that the signal curve 13 is so far apart from the desired curve 12 that it is clearly outside the tolerance range 14, so that the result of the measurement is a defective filter segment combination 10.

FIG. 2a shows a diagrammatic representation of a filter segment combination 10 in which there is a missing filter segment 31. It has been assumed in this case that a filter segment should have been arranged in place of the missing filter segment 31, which reflects a little less than the filter segments 11 and 11″, which could be, e.g., of the same material. For this reason the desired curve shown by a dashed line in FIG. 2b is somewhat lower in terms of the intensity path in the area of this filter segment that actually should have been present. A tolerance range 14 is also again shown by shading. The signal curve 13 again deviates clearly from the desired curve 12 such that it goes beyond the tolerance range 14 so that the result of this measurement is also a defective filter segment combination 10.

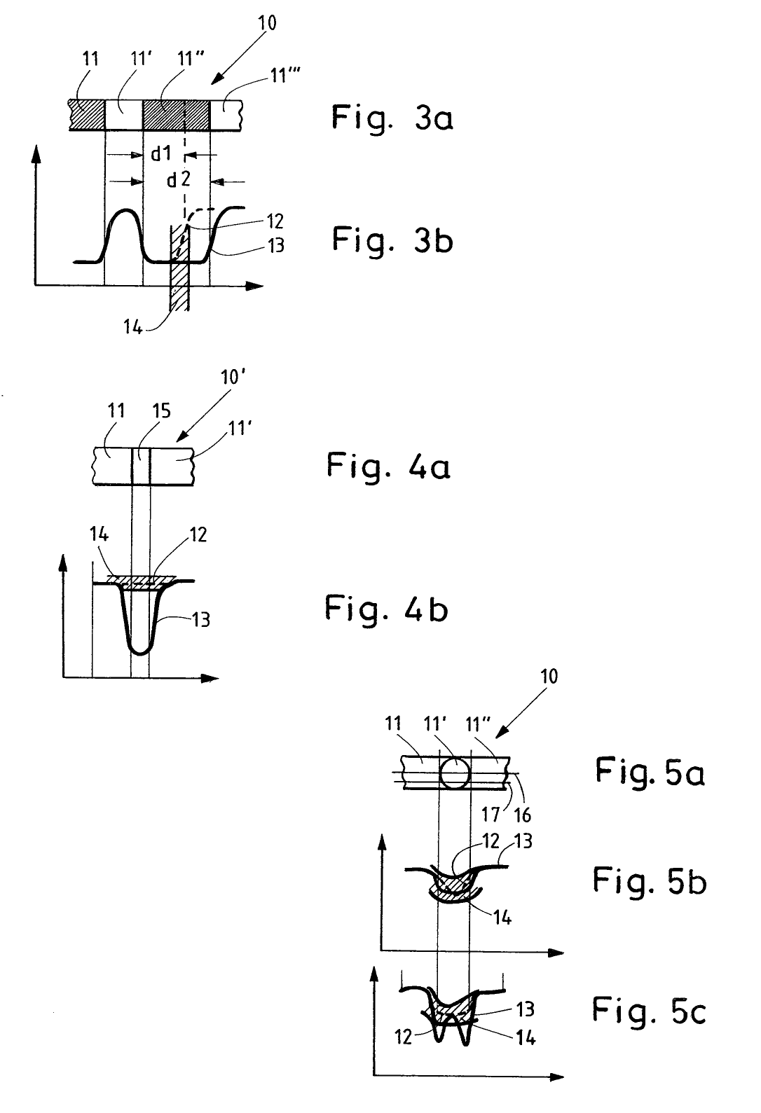

Another defect is indicated in FIG. 3a. This is a filter segment 11″ with an actual length d2 that is too large. The desired length d1 is clearly smaller than the actual length. For this reason the intensity of the measured radiation of the desired curve 12 in FIG. 3b rises earlier compared to the signal curve 13. For this reason in this case the tolerance range 14 can be regarded as a tolerance range of the distance or of the path. In this manner an incorrect position of a filter segment could also be recognized by a corresponding edge at a specific provided location or by whether this edge is at the desired location or a different location.

FIG. 4a shows a part of a multi-segment filter 10′ in a diagrammatic representation in which two filter segments 11 and 11′ are not adjacent as desired, but show too large a gap 15 between them. With materials of the filter segments 11 and 11′, for example, with the same reflection or the same transmission, the associated desired curve 12 shows at this joint an essentially straight line, which is also shown by a dashed line as is usual for desired curves 12 in this application. The signal curve 13 deviates clearly therefrom, so that the result of the measurement is a defective multi-segment filter 10′.

FIG. 4b again shows a filter segment combination 10 in diagrammatic representation in which the filter segment 11′ is tilted by 90° with respect to the longitudinal axis 30. The longitudinal axis of the tilted filter segment 11′ is tilted by 90° with respect to the longitudinal axis of the filter segments 11 and 11″ or the longitudinal axis of the filter segment combination 10. Two observation lines 16 and 17 that are spaced apart from one another are indicated diagrammatically in FIG. 5a. The observation line 16 measures from the observation direction approximately in the center of the surface of the multi-segment filter combination 10 facing the observer and the observation line 17 on the edge thereof. The signal curve or the desired curve for the measurement along the observation line 16 is shown in FIG. 5b and that of the observation line 17 is shown in FIG. 5c. It is clearly discernible that the defects would not have been recognized at all with a measurement along the observation line 16, since the signal curve lies within the tolerance range 14. However, it can be discerned in FIG. 5c that the signal curve 13 lies outside the tolerance range 14. The measurement on the edge has thus a very intrinsic advantage with a defect of this type and improves the performance of the quality control of corresponding filter segment combinations or multi-segment filters.

The inventive concept on which this application is based is that a line on the filter components or on a multi-segment filter 10′ or in a filter segment combination 10 is imaged with the aid of an imaging optical system on the photosensitive layer of a linear array of a linear camera. Light/dark differences or color differences will lead accordingly to light/dark intensities or color intensities on the lines of the linear arrays. In a very simple embodiment, e.g., with a reflection measurement, the surface of the filter components is illuminated with a normal lamp or an array of diodes and the measurement is conducted in reflection, whereby the measuring device 25 has an optical system that makes it possible to observe such a line that has an extension transverse to the longitudinal axis of the object to be measured which is smaller than the diameter of the object to be measured.

In this manner, for example, transposed filter components can be recognized by the fact that the actual intensity path on the line of the camera chip runs differently than expected. See FIG. 1b. If error components are missing, the intensity signal deviates considerably from the expected path in the relevant area. See FIG. 2b. If filter components are in the wrong position or if their length deviates from the expected value, the intensity transitions do not occur at the expected points. See FIG. 3b. If gaps occur, intensity drops occur in the signal path. See FIG. 4b. In the event of tilted filter components, characteristic changes occur in the signal path that are particularly noticeable if measurements are taken not only in the center of the filter components but also at the edge of the filter components. See FIGS. 5a through 5c.

Since filter components with an essentially white surface are increasingly being used, the actual contrasts are often much slighter than was indicated in the Figures. To boost the signal and in particular to detect gaps and to detect white/white transition points, filter techniques are used, e.g., the FIR filter technique (Finite Impulse Response), thus in particular digital filters with limited pulse response and with discrete time steps. Other filters or noise reduction devices can also be used.

The illumination is effected, e.g., with a laser light line 18 or laser beam line 18 that irradiates the surface of the filter components or the surface of the multi-segment filters. A laser micro line generator 13 LRM or 55 CM from Schäfter & Kirchhoff, for example, is suitable for this. The advantage of this type of illumination is that the light can be applied in a very concentrated manner in the circumferential direction of the filter components. It is thus possible to discern contrasts that would not be discernable with a more areal illumination. This is particularly advantageous if two scans or observation lines are provided close together, such as is indicated, e.g., in FIG. 5a.

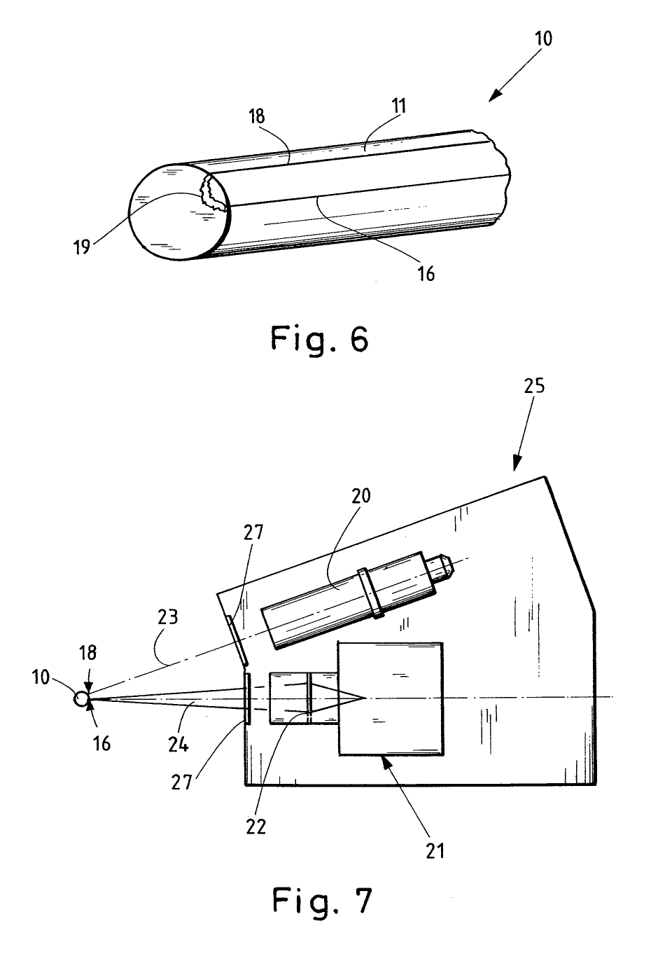

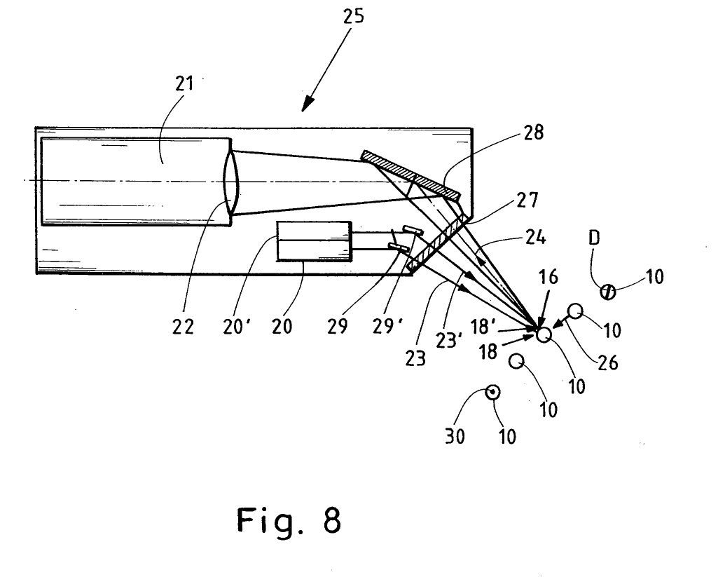

Illumination with a laser beam line 18 is also advantageous if an observation line 16 is used that is spaced apart from the laser beam line 18, as diagrammatically indicated in FIG. 6. This can be used to still distinguish properly the transition between two filter segments in the case of extremely similar white coloring of the surface and two different filter components or filter segments 11 through 11′″.

An improvement in contrast can be achieved if measurement is no longer made in direct reflection but in transmission, as is indicated in FIG. 6. To this end the transmission light 19 of an observation line is measured, as is diagrammatically indicated in FIG. 6, which transmission light is caused by the laser beam line 18. To this end the laser beam line 18 and the observation line 16 are no longer focused on one identical line, but on two lines running essentially or completely parallel close to one another, which in particular do not intersect. The light recorded by the camera has thereby penetrated the filter material. Since the light path at the joints is always different than in solid material, a contrast intensification occurs in the transitional areas.

A very simple arrangement of a corresponding device for measuring properties of multi-segment filters or combinations of filter segments of the tobacco-processing industry can be provided such that an essentially straight beam path is taken. The beam course of light sources and camera are hereby essentially straight in their optical axes.

A laser light source from Schäfter & Kirchhoff is also preferably used and a linear camera from Dalsa. The angles between the laser light source can be selected such that measurement can be made in reflection and/or in transmission.

FIG. 7 shows a measuring device 25 according to the invention that is much more space-saving than a measuring arrangement with a straight beam path. A laser light source emits a laser beam 23 that has a relatively large extension from the drawing sheet, thus generates a line beam or a laser beam line 18 on the multi-segment filter 10′. An observation line 16 is provided spaced a little apart therefrom, which observation line images through imaging of the line 16 by means of a lens 22 on a linear camera 21 or the photosensitive elements, such as, e.g., a CCD line of the linear camera 21, not shown. Moreover, corresponding windows are provided in the measuring device 25 so that the electromagnetic beams, preferably light beams, can also pass through the device.

In another embodiment or measuring device according to the invention two light sources, namely also in this case laser light sources 20, 20′, will image or illuminate the laser beam lines 18 and 18′ on filter segment combinations 10 that are spaced apart from one another. To this end the laser beams 23 and 23′ are deflected with mirrors 29 and 29′.

The filter segment combinations 10 move along the direction of movement 26, e.g., on a drum, which is not shown. Moreover, the longitudinal axis 30 of a filter segment combination 10 is shown and the diameter D.

The measuring device 25 furthermore comprises a linear camera 21 that records the light of the observation line 16 imaged through the optical system 22 and the mirror 28. The recorded light 24 is concentrated accordingly by the lens 22. On the light-sensitive element, e.g., a CCD line, which is not shown, of the linear camera 21, light reflected from the laser beam 23 in the laser beam line 18′ is guided to the line camera 21 and light transmitted from the laser beam 23 on the laser beam line 18 to the observation line 16 through the filter segment combination 10 is imaged in the linear camera 21.

It could now additionally be provided to use another linear camera 21 in order to also image an observation line 17, not shown, in the other linear camera, not shown, whereby the observation line 17 is spaced apart from the observation line 16 and can also be arranged spaced apart from the laser beam line 18 in order to improve the contrast for the transmission measurement. The other observation line 17 could also coincide with the laser beam line 18. It can also be provided to switch on the two light sources alternately or to alternately block out laser beams 23 and 23′ in order in this manner to prevent a mutual interference with the reflection measurement and the transmission measurement.

This can occur in a cycle in which a single filter segment combination 10 is located in corresponding measuring positions.

The recording of measured values preferably occurs with contact image sensors.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

10 Filter segment combination
10′ Multi-segment filter
11, 11′, 11″, 11′″ Filter segment
12 Desired curve
13 Signal curve
14 Tolerance range
15 Gap
16 Observation line
17 Observation line
18, 18′ Laser beam line
19 Transmission light
20, 20′ Laser light source
21 Linear camera
22 Lens
23, 23′ Laser beam
24 Recorded light
25 Measuring device
26 Direction of movement
27 Window
28 Mirror
29, 29′ Mirror
30 Longitudinal axis
31 Missing filter segment
d1 Desired length
d2 Actual length
D Diameter

What is claimed:

1. A device for measuring properties of combination of filter segments of the tobacco-processing industry, comprising:
an illumination device structured and arranged to essentially uniformly illuminate, in a longitudinally axial manner, at least one section of the combination of filter segments; and
a photodetector,
wherein the illumination device images a first line of electromagnetic radiation on the combination of filter segments having an extension transverse to the longitudinal axis of the combination of filter segments smaller than a diameter of the combination of filter segments.

2. The device in accordance with claim 1, wherein the combination of filter segments comprises multi-segment filters.

3. The device in accordance with claim 1, wherein the extension of the first line transverse to the longitudinal axis of the combination of filter segments is less than half the diameter of the combination of filter segments.

4. The device in accordance with claim 1, wherein the extension of the first line is less than one quarter of the diameter of the combination of filter segments.

5. The device in accordance with claim 1, wherein the extension of the first line is less than one eighth of the diameter of the combination of filter segments.

6. The device in accordance with claim 1, wherein the illumination device comprises a linear laser.

7. The device in accordance with claim 1, wherein the photodetector comprises an optical system that images a second line in a longitudinally axial manner on the combination of filter segments.

8. The device in accordance with claim 7, wherein the second line is arranged at an edge of the combination of filter segments.

9. The device in accordance with claim 1, wherein the photodetector comprises a linear camera.

10. The device in accordance with claim 1, wherein the photodetector comprises a charged coupled device line.

11. The device in accordance with claim 7, wherein the second line is spatially apart from the first line.

12. The device in accordance with claim 11, wherein the illumination device further images another first line, such that the another first line lies on the second line.

13. The device in accordance with claim 11, wherein the photodetector further images another second line, such that the another second line lies on the first line.

14. A method for measuring properties of combinations of filter segments of the tobacco-processing industry, the method comprising:
illuminating the combination of filter segments with a first line of electromagnetic radiation;
recording the electromagnetic radiation at least one of reflected and scattered by the combination of filter segments; and
comparing the recorded radiation with desired values, and when a deviation beyond a predetermined tolerance range is detected, the combination of filter segments are deemed defective,
wherein an extension of the first line transversely to the longitudinal axis of the combination of filter segments is smaller than a diameter of the combination of filter segments.

15. The method in accordance with claim 14, wherein the combination of filter segments comprises multi-segment filters.

16. The method in accordance with claim 14, wherein the desired values are predetermined or preset.

17. The method in accordance with claim 14, wherein the extension of the first line transversely to the longitudinal axis of the combination of filter segments is less than half of the diameter of the combination of filters.

18. The method in accordance with claim 14, wherein the extension of the first line is less than one quarter of the diameter of the combination of filter segments.

19. The method in accordance with claim 14, wherein the extension of the first line is less than one eighth of the diameter of the combination of filter segments.

20. The method in accordance with claim 14, wherein the recording of electromagnetic radiation comprises imaging a second line in a longitudinally axial manner on the combination of filter segments by a recording device.

21. The method in accordance with claim 20, wherein the second line is arranged at an edge of the combination of filter segments.

22. The method in accordance with claim 20, wherein the second line is spatially apart from the first line.

23. The method in accordance with claim 20, wherein the second line lies on the first line.

24. The method in accordance with claim 23, wherein another first line is illuminated, such that one of the first line and the another first line lie on the second line.

25. The method in accordance with claim 23, wherein another second line is imaged, such that one of the second line and the another second line lie on the first line.

26. A machine of the tobacco-processing industry with a device according to claim 1.
